(19) United States
(12) Patent Application Publication
(10) Pub. No.: US 2016/0171938 A1
(43) Pub. Date: Jun. 16, 2016

(54) LIQUID CRYSTAL DISPLAY DEVICE

(71) Applicant: Samsung Display Co., Ltd., Yongin-City (KR)

(72) Inventors: Yeon Sun NA, Yongin-si (KR); Dong In KIM, Suwon-si (KR); Ji Young EOM, Daedeok-gu (KR)

(21) Appl. No.: 14/681,929

(22) Filed: Apr. 8, 2015

(30) Foreign Application Priority Data
Dec. 15, 2014 (KR) 10-2014-0180020

(51) Int. Cl. G09G 3/36

(52) U.S. Cl. CPC G09G 3/3607; G09G 3/3677; G09G 3/3688; G09G 2340/04; G09G 2330/021; G09G 2310/0286; G09G 2310/08; G09G 2310/027; G09G 2300/0452

(57) ABSTRACT

A liquid crystal display (LCD) device. The liquid crystal display device comprises a data driver including a first data driving unit, which is connected to first through third data lines, and a second data driving unit, which is connected to fourth through sixth data lines, a display panel including a first pixel group, which has first through third pixel units that are connected to the first data driving unit via the first through third data lines, respectively, and a second pixel group, which has fourth through sixth pixel units that are connected to the second data driving unit via the fourth through sixth data lines, respectively; and a switching circuit unit including a first transistor, a second transistor, and a third transistor, which is connected between the third and sixth data lines.

### CLAIM OF PRIORITY

This application makes reference to, incorporates the same herein, and claims all benefits accruing under 35 U.S.C. §119 from an application earlier filed in the Korean Intellectual Property Office on 15 Dec. 2014 and there duly assigned Serial No. 10-2014-0180020.

### BACKGROUND OF THE INVENTION

1. Field of the Invention

The invention relates to a liquid crystal display (LCD) device.

2. Description of the Related Art

A liquid crystal display (LCD) device, which is one of the most widely used flat panel display devices, includes two substrates having field generating electrodes such as pixel electrodes and a common electrode formed thereon and a liquid crystal layer disposed between the two substrates. The LCD device displays an image by applying a voltage to the field generating electrodes to generate an electric field in the liquid crystal layer, determining the orientation of liquid crystal molecules in the liquid crystal layer and controlling the polarization of light incident thereupon. Recently, an increasing number of LCD devices have been designed to be able to realize a large screen, a high resolution and an ultra-high picture quality.

However, as the operating speed, resolution and picture quality of LCD devices increase due to rapid developments in technology, the number of data lines and scan lines required and the power consumption of LCD devices also increase accordingly.

### SUMMARY OF THE INVENTION

Exemplary embodiments of the invention provide a liquid crystal display (LCD) device capable of allowing a user to switch the LCD device from one driving mode to another driving mode and to adjust resolution.

However, exemplary embodiments of the invention are not restricted to those set forth herein. The above and other exemplary embodiments of the invention will become more apparent to one of ordinary skill in the art to which the invention pertains by referencing the detailed description of the invention given below.

According to an exemplary embodiment of the invention, a liquid crystal display (LCD) device, may comprise a data driver including a first data driving unit, which is connected to first through third data lines, and a second data driving unit, which is connected to fourth through sixth data lines, a display panel including a first pixel group, which has first through third pixel units that are connected to the first data driving unit via the first through third data lines, respectively, and a second pixel group, which has fourth through sixth pixel units that are connected to the second data driving unit via the fourth through sixth data lines, respectively; and a switching circuit unit including a first transistor, which is connected between the first and fourth data lines, a second transistor, which is connected between the second and fifth data lines, and a third transistor, which is connected between the third and sixth data lines.

The first data driving unit may include first through third digital-to-analog converters (DACs), which are connected to the first through third data lines, respectively, the second data driving unit may include fourth through sixth DACs, which are connected to the fourth through sixth data lines, respectively, and the data driver may further include a fourth transistor, which is connected between the fourth DAC and the fourth data line, a fifth transistor, which is connected between the fifth DAC and the fifth data line, and a sixth transistor, which is connected between the sixth DAC and the sixth data line.

The first through third transistors may perform a switching operation that is complementary to a switching operation performed by the fourth through sixth transistors.

The first through third pixel units may display first through third colors, respectively, which are different from one another, and the fourth through sixth pixel units may display the first through third colors, respectively.

The display panel may further include a third pixel group, which is connected to the first data driving unit via the first through third data lines, and a fourth pixel group, which is connected to the second data driving unit via the fourth through sixth data lines.

The LCD device may further comprise a scan driving unit connected to the display panel via a plurality of scan lines, wherein the scan driving unit may be connected to the first and second pixel groups via one of the scan lines and may be connected to the third and fourth pixel groups via another one of the scan lines.

The LCD device may further comprise a seventh transistor connected between the scan line to which the first and second pixel groups are connected and the scan line to which the third and fourth pixel groups are connected, wherein the scan driving unit may further include a shift register, which provides a scan signal to the scan line to which the third and fourth pixel groups are connected, and an eighth transistor, which may be connected to the scan line to which the third and fourth pixel groups are connected.

The seventh transistor may perform a switching operation that is complementary to a switching operation performed by the eighth transistors.

In other aspect of the exemplary embodiment of the invention, an LCD device, comprising: a data driver including a first data driving unit, which provides first through third data signals via first through third data lines, respectively, and a second data driving unit, which provides fourth through sixth data signals via fourth through sixth data lines, respectively; a display panel including a first pixel group, which has first through third pixel units that are provided with the first through third data signals, respectively, and a second pixel group, which has fourth through sixth pixel units that are provided with the fourth through sixth data signals, respectively; a switching circuit unit including a first transistor, which is connected between the first and fourth data lines, a second transistor, which is connected between the second and fifth data lines, and a third transistor, which is connected between the third and sixth data lines; and a timing control unit turning on the first through third transistors by providing a first control signal to the switching circuit unit during a first driving mode and turning off the first through third transistors by providing a second control signal to the switching circuit unit during a second driving mode.

The data driver may include a first transistor, which establishes or blocks a signal path between the first and fourth data lines in response to first or second control signal being provided thereto, a second transistor, which establishes or blocks a signal path between the second and fifth data lines in response to the first or second control signal being provided thereto, and a third transistor, which establishes or blocks a signal path between the third and sixth data lines in response to the first or second control signal being provided thereto.

The first data driving unit may include first through third digital-to-analog converters (DACs), which are connected to the first through third data lines, respectively, the second data driving unit may include fourth through sixth DACs, which are connected to the fourth through sixth data lines, respectively, and the data driver may further include fourth through sixth transistors, which block signal paths between output terminals of the fourth through sixth DACs, respectively, and the fourth through sixth data lines, respectively, during the first driving mode.

The first through third pixel units may display first through third colors, respectively, which are different from one another, and the fourth through sixth pixel units display the first through third colors, respectively.

The LCD device may further comprise a scan driving unit including a plurality of shift registers, which provide a plurality of scan signals via the display panel and a plurality of scan lines, wherein the first and second pixel groups are provided with a scan signal via one of the scan lines.

The display panel may further include a third pixel group, which receives the first through third data signals from the first data driving unit, and a fourth pixel group, which receives the fourth through sixth data signals from the second data driving unit, and the third and fourth pixel groups are provided with a scan signal via another one of the scan lines.

The LCD device may further comprise a seventh transistor establishing a signal path between the scan line to which the first and second pixel groups are connected and the scan line to which the third and fourth pixel groups are connected during the first driving mode and blocking the signal path between the scan line to which the first and second pixel groups are connected and the scan line to which the third and fourth pixel groups are connected during the second driving mode, wherein the scan driving unit blocks a signal path between one of the shift registers providing a scan signal to the third and fourth pixel groups and the scan line to which the third and fourth pixel groups are connected, during the first driving mode.

In other aspect of the exemplary embodiment of the invention, an LCD device, may comprise a display panel including a first pixel group, which has first and second pixel units that display a first color, a second pixel group, which has third and fourth pixel units that display a second color, and a third pixel group, which has fifth and sixth pixel units that display a third color; a data driver including a first data driving unit, which is connected to the first and second pixel units via first and second data lines, respectively, a second data driving unit, which is connected to the third and fourth pixel units via third and fourth data lines, respectively, and a third data driving unit, which is connected to the fifth and sixth pixel units via fifth and sixth data lines, respectively; and a switching circuit unit including a first transistor, which is connected between the first and second data lines, a second transistor, which is connected between the third and fourth data lines, and a third transistor, which is connected between the fifth and sixth data lines.

The data driver may further include first through sixth digital-to-analog converters (DACs), which are connected to the first through sixth data lines, respectively, the first data driving unit may include a fourth transistor, which is connected between the second DAC and the second data line, the second data driving unit may include a fifth transistor, which is connected between the fourth DAC and the fourth data line, and the third data driving unit may include a sixth transistor, which is connected between the sixth DAC and the sixth data line.

The first through third transistors may perform a switching operation that is complementary to a switching operation performed by the fourth through sixth transistors.

The display panel may further include a fourth pixel group, which is connected to the first data driving unit via the first and second data lines, a fifth pixel group, which is connected to the second data driving unit via the third and fourth data lines, and a sixth pixel group, which is connected to the third data driving unit via the fifth and sixth data lines.

The LCD device may further comprise a scan driving unit connected to the first through third pixel groups via one of a plurality of scan lines and to the fourth through sixth pixel groups via another one of the scan lines; and a seventh transistor connected between the scan line to which the first through third pixel groups are connected and the scan line to which the fourth through sixth pixel groups are connected, wherein the scan driving unit may include an eighth transistor, which is connected between the scan line to which the fourth through sixth pixel groups are connected and an output terminal of a shift register providing a scan signal to the scan line to which the fourth through sixth pixel groups are connected.

According to the exemplary embodiments, it is possible for a user to switch an LCD device from one driving mode to another driving mode. In addition, it is possible to reduce the power consumption of the LCD device by adjusting the resolution of the LCD device according to the driving mode of the LCD device.

Other features and exemplary embodiments will be apparent from the following detailed description, the drawings, and the claims.

### BRIEF DESCRIPTION OF THE DRAWINGS

A more complete appreciation of the present invention, and many of the attendant advantages thereof, will become readily apparent as the same becomes better understood by reference to the following detailed description when considered in conjunction with the accompanying drawings in which like reference symbols indicate the same or similar components, wherein:

FIG. 1 is a block diagram of a liquid crystal display (LCD) device according to an exemplary embodiment of the invention;

FIG. 2 is a detailed block diagram illustrating a data driver and a switching circuit unit illustrated in FIG. 1;

FIG. 3 is a detailed block diagram illustrating a scan driving unit illustrated in FIG. 1;

FIG. 4 is a detailed block diagram illustrating an operation of the LCD device in a first driving mode;

FIG. 5 is a detailed block diagram illustrating an operation of the LCD device in a second driving mode;

FIG. 6 is a block diagram of an LCD device according to another exemplary embodiment of the invention; and

FIG. 7 is a detailed block diagram illustrating a data driver and a switching circuit unit illustrated in FIG. 6.

### DETAILED DESCRIPTION OF THE INVENTION

Advantages and features of the present invention and methods of accomplishing the same may be understood more readily by reference to the following detailed description of preferred embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section.

Thus, a first element, component, region, layer or section discussed below could be termed a second element, component, region, layer or section without departing from the teachings of the present invention.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, these embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

Hereinafter, embodiments of the present invention will be described with reference to the accompanying drawings.

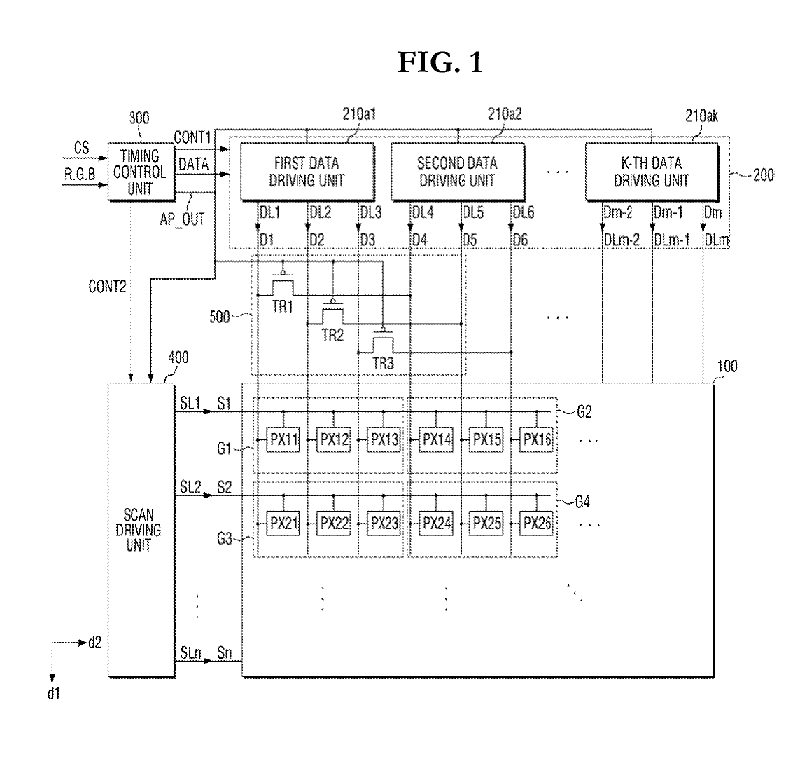

FIG. 1 is a block diagram of a liquid crystal display (LCD) device according to an exemplary embodiment of the invention.

Referring to FIG. 1, the LCD device according to an exemplary embodiment of the invention may include a display panel 100, a data driver 200, a timing control unit 300, a scan driving unit 400 and a switching circuit unit 500.

The display panel 100 may be a region where an image is displayed. The display panel 100 may include a first substrate (not illustrated), a second substrate (not illustrated), which faces the first substrate, and a liquid crystal layer (not illustrated), which is disposed between the first and second substrates. That is, the display panel 100 may be a liquid crystal panel. The first substrate may be an array substrate where a plurality of pixel groups and lines connected to the pixel groups are formed, and the second substrate may be an encapsulation substrate which covers the first substrate. A common electrode may be formed on a surface of the second substrate facing the first substrate. The common electrode may generate a vertical electrical field together with pixel electrodes formed on the first substrate, and the alignment of liquid crystal molecules in the liquid crystal layer may be controlled according to the electric field. That is, a common voltage Vcom may be applied to the common electrode, and a voltage corresponding to a data signal may be applied to the pixel electrodes, thereby generating an electric field corresponding to the difference between the common voltage Vcom and the voltage corresponding to the data signal in a pixel unit of each of the pixel groups. However, the structure of the display panel 100 is not limited to that set forth herein. That is, the common electrode may be formed on the first substrate, in which case, the alignment of the liquid crystal molecules may be controlled according to a horizontal electric field generated by the common electrode and the pixel electrodes on the first substrate. The optical transmittance of the display panel 100 may be controlled according to the alignment of the liquid crystal molecules, which varies according to an electric field.

The display panel 100 may be connected to a plurality of first through n-th scan lines SL1 through SLn (where n is a natural number greater than 1) and a plurality of first through m-th data lines DL1 through DLm (where m is a natural number greater than 1), which are arranged to intersect the scan lines SL1 through SLn. The scan lines SL1 through SLn, the data lines DL1 through DLm and the pixel groups may be formed on the first substrate of the display panel 100. The pixel groups may be arranged in a matrix form. The data lines DL1 through DLm, the scan lines SL1 through SLn and the pixel groups may be disposed on the first substrate while being insulated from one another. The data lines DL1 through DLm may extend in a first direction d1 in parallel to one another. The scan lines SL1 through SLn may extend in a second direction d2 in parallel to one another. As illustrated in FIG. 1, the first direction d1 may be a column direction, and the second direction d2 may be a row direction.

Each of the pixel groups may include a plurality of pixel units, which display different colors. In an exemplary embodiment, each of the pixel groups may include three pixel units, which display different colors. For convenience, the pixel groups will hereinafter be described, taking first through fourth pixel groups G1 through G4 as an example. The first pixel group G1 may include first through third pixel units PX11 through PX13, which are connected to the first through third data lines DL1 through DL3, respectively. The second pixel group G2 may include fourth through sixth pixel units PX14 through PX16, which are connected to the fourth through sixth data lines DL4 through DL6, respectively. The third pixel group G3 may include seventh through ninth pixel units PX21 through PX23, which are connected to the first through third data lines DL1 through DL3, and the fourth pixel group G4 may include tenth through twelfth pixel units PX24 through PX26, which are connected to the fourth through sixth data lines DL4 through DL6. The first and second pixel groups G1 and G2 may be connected to the first scan line SL1, and the third and fourth pixel groups G3 and G4 may be connected to the second scan line SL2. Each of the pixel units included in each of the pixel groups may be provided with a data signal via a data line connected thereto according to a scan signal provided thereto via a scan line connected thereto. For this, each of the pixel units included in each of the pixel groups may include a transistor (not shown), which is turned on by a scan signal (S1˜Sn) and then applies a data signal (D1˜Dm) to a pixel electrode. Each of the pixel units included in each of the pixel groups may display one of first through third colors. For example, the first color may be red, the second color may be green, and the third color may be blue. The first and fourth pixel units PX11 and PX14 may display the first color, i.e., red, the second and fifth pixel units PX12 and PX15 may display the second color, i.e., green, and the third and sixth pixel units PX13 and PX16 may display the third color, i.e., blue. Pixel units connected to the same data line may display the same color together.

The data driver 200 may include a plurality of first through k-th data driving units 210a1 through 210ak (where k is a multiple of 2). The first data driving unit 210a1 may be connected to the first and third pixel groups G1 and G3 via the first through third data lines DL1 through DL3. The second driving unit 210a2 may be connected to the second and fourth pixel groups G2 and G4 via the fourth through sixth data lines DL4 through DL6. The data driver 200 may receive a control signal CONT1 and image data DATA from the timing control unit 300. The first through k-th data driving units 210a1 through 210ak of the data driver 200 may generate a plurality of first through m-th data signals D1 through Dm by sampling and holding the image data DATA input thereto according to the control signal CONT1 and converting the sampled-and-held image data into analog voltage data. The first through k-th data driving units 210a1 through 210ak may provide the data signals D1 through Dm to the display panel 100 via the data lines DL1 through DLm. Each pixel unit of the display panel 100 may display an image corresponding to a data signal provided thereto via one of the data lines DL1 through DLm in response to a scan signal S1 through Sn being applied thereto via one of the scan lines SL1 through SLn.

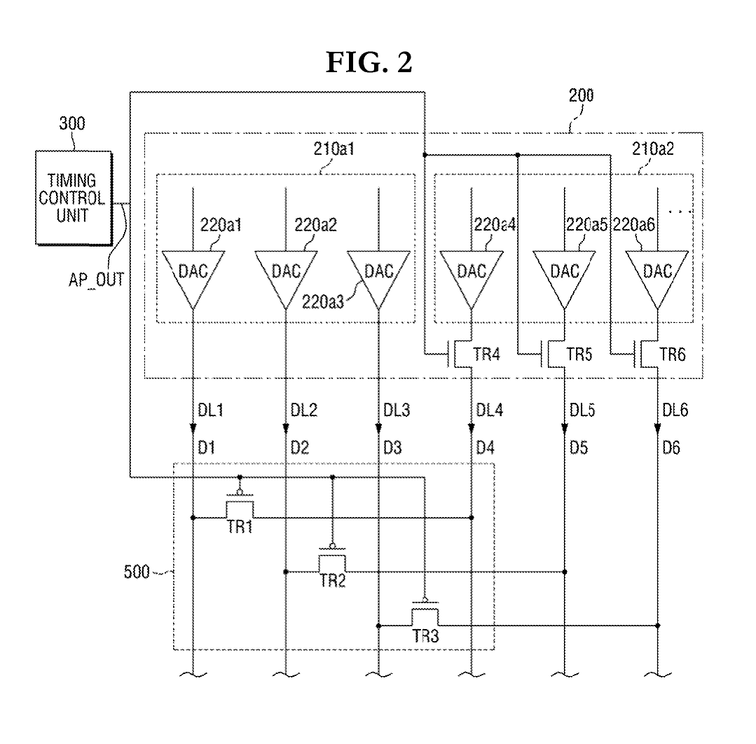

The timing control unit 300 may receive an image signal “R.G.B” and a control signal CS for controlling the image signal “R.G.B” from an external source (not illustrated). Examples of the control signal CS may include a vertical synchronization signal, a horizontal synchronization signal, a main clock signal, and a data enable signal. The timing control unit 300 may process the control signal CS to be suitable for the operating conditions of the display panel 100, and may generate the image data DATA, the first control signal CONT1 and a second control signal CONT2. Examples of the first control signal CONT1 may include a horizontal synchronization start signal indicating the start of the input of the image data DATA, and a load signal for controlling the application of a data voltage to each of the data lines DL1 through DLm. Examples of the second control signal CONT2 may include a scan initiation start signal for instructing the start of the output of the scan signals S1 through Sn and a gate clock signal for controlling when to output a scan-on pulse. The timing control unit 300 may provide a control signal AP_OUT to the data driver 200, the scan driving unit 400 and the switching circuit unit 500, and may thus control the switching operation of a plurality of transistors included in the switching circuit unit 500, a plurality of transistors included in the data driver 200 and a plurality of transistors included in the scan driving unit 400. The operation of the timing control unit 300 will be described later in detail with reference to FIG. 2.

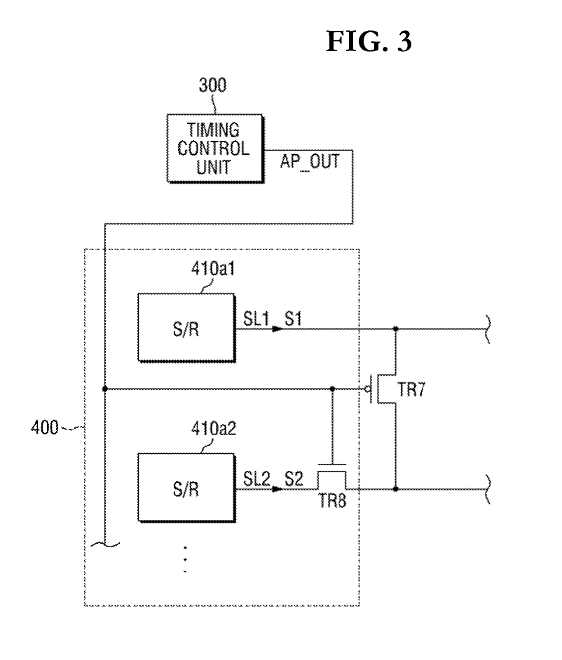

The scan driving unit 400 may receive the second control signal CONT2 from the timing control unit 300. The scan driving unit 300 may provide a plurality of first through n-th scan signals S1 through Sn to the display panel 100 according to the second control signal CONT2. The scan driving unit 400 may include a plurality of shift registers. The structure of the scan driving unit 400 will be described later in detail with reference to FIG. 3.

The switching circuit unit 500 may include first through third transistors TR1 through TR3. The first transistor TR1 may be connected between the first and fourth data line DL1 and DL4, receives the control signal AP_OUT from the timing control unit 300, and establishes or blocks a signal path between the first and fourth data line DL1 and DL4. The second transistor TR2 may be connected between the second and fifth data lines DL2 and DL5, receives the control signal AP_OUT from the timing control unit 300, and establishes or blocks a signal path between the second and fifth data lines DL2 and DL5. The third transistor TR3 may be connected between the third and sixth data lines DL3 and DL6, receives the control signal AP_OUT from the timing control unit 300, and establishes or blocks a signal path between the third and sixth data lines DL3 and DL6. In an exemplary embodiment, the first through third transistors TR1 through TR3 may be P-type metal-oxide-semiconductor (PMOS) transistors. The first through third transistors TR1 through TR3 may be turned on in response to a low-level control signal AP_OUT being provided thereto from the timing control unit 300. The location of the switching circuit unit 500 is not necessarily limited. In an exemplary embodiment, the switching circuit unit 500 may be formed on the first substrate of the display panel 100. In an exemplary embodiment, the switching circuit unit 500 may include the first through third transistors TR1 through TR3, and may also include a plurality of other transistors connected to the third to k-th data driving units 210a3 through 210ak.

FIG. 2 is a detailed block diagram illustrating the data driver 200 and the switching circuit unit 500.

Referring to FIGS. 1 and 2, the data driver 200 may include the first data driving unit 210a1, which is connected to the first pixel group G1 via the first through third data lines DL1 through DL3, and the second data driving unit 210a2, which is connected to the second pixel group G2 via the fourth through sixth data lines DL4 through DL6. The first data driving unit 210a1 may include first through third digital-to-analog converters (DACs) 220a1 through 220a3. The first through third DACs 220a1 through 220a3 may provide the first through third data signals D1 through D3, respectively, to the first through third data lines DL1 through DL3, respectively. The second data driving unit 210a2 may include fourth through sixth DACs 220a4 through 220a6. The fourth through sixth DACs 220a4 through 220a6 may provide the fourth through sixth data signals D4 through D6, respectively, to the fourth through sixth data lines DL4 through DL6, respectively. The second data driving unit 210a2 may also include fourth through sixth transistors TR4 through TR6. The fourth through sixth transistors TR4 through TR6 may be connected between the output terminals of the fourth through sixth DACs 220a4 through 220a6, respectively, and the fourth through sixth data lines DL4 through DL6, respectively. The fourth through sixth transistors TR4 through TR6 may receive the control signal AP_OUT from the timing control unit 300, and may establish or block signal paths between the output terminals of the fourth through sixth DACs 220a4 through 220a6, respectively, and the fourth through sixth data lines DL4 through DL6, respectively, according to the control signal AP_OUT. In an exemplary embodiment, the fourth through sixth transistors TR4 through TR6 may be N-type metal oxide semiconductor (NMOS) transistors. The fourth through sixth transistors TR4 through TR6 may be turned on in response to a high-level control signal AP_OUT being provided thereto from the timing control unit 300. In an exemplary embodiment, the first through third transistors TR1 through TR3 may be PMOS transistors, and the fourth through sixth transistors TR4 through TR6 may be NMOS transistors. However, the invention is not limited to this exemplary embodiment. That is, the first through third transistors TR1 through TR3 and the fourth through sixth transistors TR4 through TR6 are not necessarily limited to any particular switching types as long as the first through third transistors TR1 through TR3 and the fourth through sixth transistors TR4 through TR6 perform switching operations that are complementary to each other. The fourth through sixth transistors TR4 through TR6 may be connected to the output terminals of the fourth through sixth DACs 220a4 through 220a6, respectively. The fourth through sixth transistors TR4 through TR6 may also be connected (not shown) to the first through third DACs 220a1 through 220a3, respectively, in the first driving circuit unit 210a1.

FIG. 3 is a detailed block diagram illustrating the scan driving unit 400.

Referring to FIGS. 1 and 3, the scan driving unit 400 may include a plurality of shift registers, and the plurality of shift registers include first and second shift registers 410a1 and 410a2. The plurality of shift registers may be dependently connected to one another in cascade (not shown). The plurality of shift registers may be connected, and may provide the scan signals S1 through Sn, respectively, to the scan lines SL1 through SLn, respectively. The first shift register 410a1 may provide the first scan signal S1 to the first scan line SL1, and the second shift register 410a2 may provide the second scan signal S2 to the second scan line SL2. The LCD device according to an exemplary embodiment of the invention may also include a seventh transistor TR7, which is connected between the first and second scan lines SL1 and SL2. The seventh transistor TR7 may receive the control signal AP_OUT from the timing control unit 300, and may establish or block a signal path between the first and second scan lines SL1 and SL2 according to the control signal AP_OUT. The seventh transistor TR7 may be included in the scan driving unit 400. In the description that follows, it is assumed that the seventh transistor TR7 is included in the scan driving unit 400. The scan driving unit 400 may also include an eighth transistor TR8, which is connected between the output terminal of the second shift register 410a2 and the second scan line SL2. The eighth transistor TR8 may establish or block a signal path between the output terminal of the second shift register 410a2 and the second scan line SL2. In an exemplary embodiment, the seventh and eighth transistors TR7 and TR8 may be PMOS and NMOS transistors, respectively, but the invention is not limited thereto. That is, the seventh and eighth transistors TR7 and TR8 are not necessarily limited to any particular switching types as long as they perform switching operations that are complementary to each other. The eighth transistor TR8 may be connected to the input terminal of the second shift register 410a2. The eighth transistor TR8 may also be connected (not shown) between the first shift register 410a2 and the first scan line SL1. The LCD device according to an exemplary embodiment of the invention has been described above as having only the seventh transistor TR7 connected between the first and second scan lines SL1 and SL2, but may also include a plurality of other transistors connected between two of the third through n-th scan lines SL3 through SLn, in which case, a transistor establishing or blocking a signal path to a shift register that outputs a scan signal may be connected to one of the two scan lines.

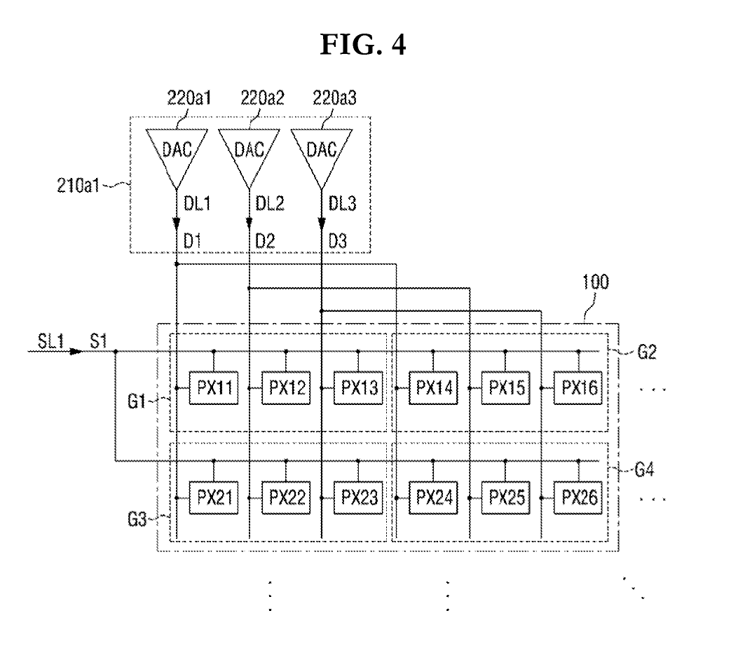

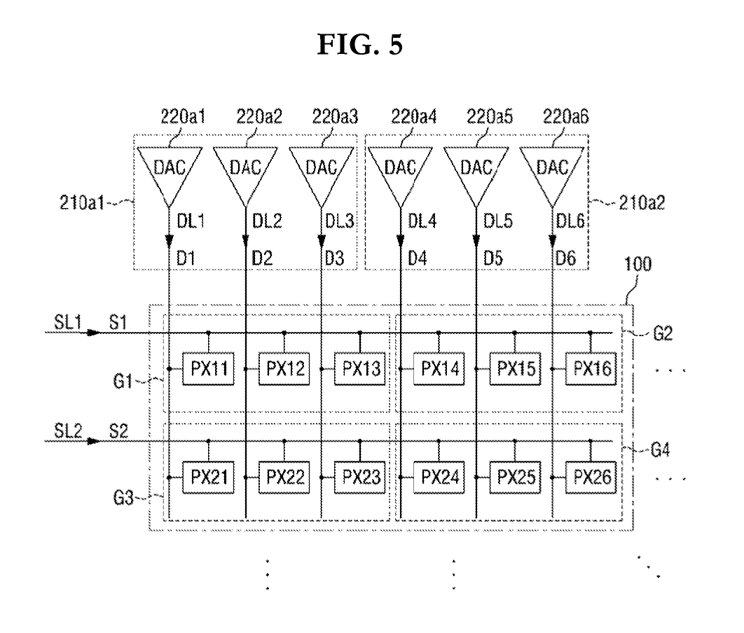

FIG. 4 is a detailed block diagram illustrating an operation of the LCD device according to an exemplary embodiment of the invention in a first driving mode. FIG. 5 is a detailed block diagram illustrating an operation of the LCD device according to an exemplary embodiment of the invention in a second driving mode. For convenience, the operation of the LCD device according to an exemplary embodiment of the invention will hereinafter be described, taking the first through fourth pixel groups G1 through G4 as an example.

Referring to FIGS. 1, 2, 3 and 4, during the first driving mode, the timing control unit 300 may provide the low-level control signal AP_OUT to the data driver 200, the scan driving unit 400 and the switching circuit unit 500. The first through third transistors TR1 through TR3 of switching circuit unit 500 may be turned on in response to the low-level control signal AP_OUT being provided thereto, and may establish signal paths between the first and fourth data lines DL1 and DL4, between the second and fifth data lines DL2 and DL5 and between the third and sixth data lines DL3 and DL6, respectively. The fourth through sixth transistors TR4 through TR6 may be turned off in response to the low-level control signal AP_OUT being provided thereto, and may block the output of the fourth through sixth DACs 220a4 through 220a6, respectively. The seventh transistor TR7 may be turned on in response to the low-level control signal AP_OUT being provided thereto, and may establish a signal path between the first and second scan lines SL1 and SL2. The eighth transistor TR8 may be turned off in response to the low-level control signal AP_OUT being provided thereto, and may block the output of the second shift register 410a2. Accordingly, the first through fourth pixel groups G1 through G4 may be provided with the first through third data signals D1 through D3 via the first through third data lines DL1 through DL3. Also, the third and fourth pixel groups G3 and G4 may be provided with the first scan signal S1 via the first scan line SL1. Therefore, the pixel units PX11, PX14, PX21 and PX24 may display the first color according to the first data signal D1 in response to receipt of the first scan signal S1, the pixel units PX12, PX15, PX22 and PX25 may display the second color according to the second data signal D2 in response to receipt of the first scan signal S1, and the pixel units PX13, PX16, PX23 and PX26 may display the third color according to the third data signal D3 in response to receipt of the first scan signal S1. In this manner, during the first driving mode, the first through fourth pixel groups G1 through G4 may operate as a single unit, and only half the data lines DL1 through DLm and half the scan lines SL1 through SLn may be used. Accordingly, the power consumption of the display panel 100 may be lowered. That is, during the first driving mode, the LCD device according to an exemplary embodiment may operate at a full high definition (FHD) resolution.

Referring to FIGS. 1, 2, 3 and 5, during the second driving mode, the timing control unit 300 may provide the high-level control signal AP_OUT to the data driver 200 and the scan driving unit 400. The first through third transistors TR1 through TR3 may be turned off in response to the high-level control signal AP_OUT being provided thereto, and may block the signal paths between the first and fourth data lines DL1 and DL4, between the second and fifth data lines DL2 and DL5 and between the third and sixth data lines DL3 and DL6, respectively. The fourth through sixth transistors TR4 through TR6 may be turned on in response to the high-level control signal AP_OUT being provided thereto, and may provide the output of the fourth through sixth DACs 220a4 through 220a6, respectively, to the fourth through sixth data lines DL4 through DL6, respectively. The seventh transistor TR7 may be turned off in response to the high-level control signal AP_OUT being provided thereto, and may block the signal path between the first and second scan lines SL1 and SL2. The eighth transistor TR8 may be turned on in response to the low-level control signal AP_OUT being provided thereto, and may provide the output of the second shift register 410a2 to the second scan line SL2. Accordingly, the first and third pixel groups G1 and G3 may be provided with the first through third data signals D1 through D3 via the first through third data lines DL1 through DL3, and the second and fourth pixel groups G2 and G4 may be provided with the fourth through sixth data signals D4 through D6 via the fourth through sixth data lines DL4 through DL6. Also, the first and second pixel groups G1 and G2 may be provided with the first scan signal S1 via the first scan line SL1, and the third and fourth pixel groups G3 and G4 may be provided with the second scan signal S2 via the second scan line SL2. Therefore, the pixel units PX11 and PX21 may display the first color according to the first data signal D1, the pixel units PX12 and PX22 may display the second color according to the second data signal D2, and the pixel units PX13 and PX23 may display the third color according to the third data signal D3. During the second driving mode, unlike during the first driving mode, the fourth through sixth transistors TR4 through TR6 are turned on. Accordingly, the pixel units PX14 and PX24 may display the first color according to the fourth data signal D3, the pixel units PX15 and PX25 may display the second color according to the fifth data signal D5, and the pixel units PX16 and PX26 may display the third color according to the sixth data signal D6. In this manner, during the second driving mode, the first through fourth pixel groups G1 through G4 may operate as a single unit, and the data lines DL1 through DLm and the scan lines SL1 through SLn may all be used. Accordingly, the display panel 100 may realize a high resolution. That is, during the second driving mode, the LCD device according to an exemplary embodiment may operate at an ultra-high definition (UHD) resolution.

In short, the resolution of the LCD device according to an exemplary embodiment of the invention may be adjusted according to the control signal AP_OUT from the timing control unit 300. Also, since during the first driving mode, the number of scan lines and data lines from which to output signals may be reduced, the power consumption of the LCD device according to an exemplary embodiment of the invention may be lowered.

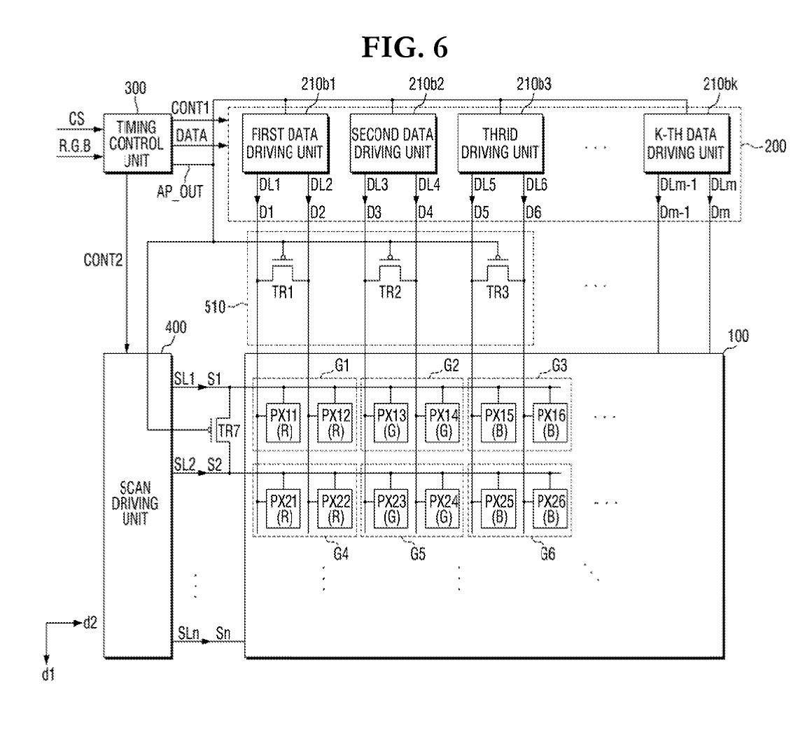

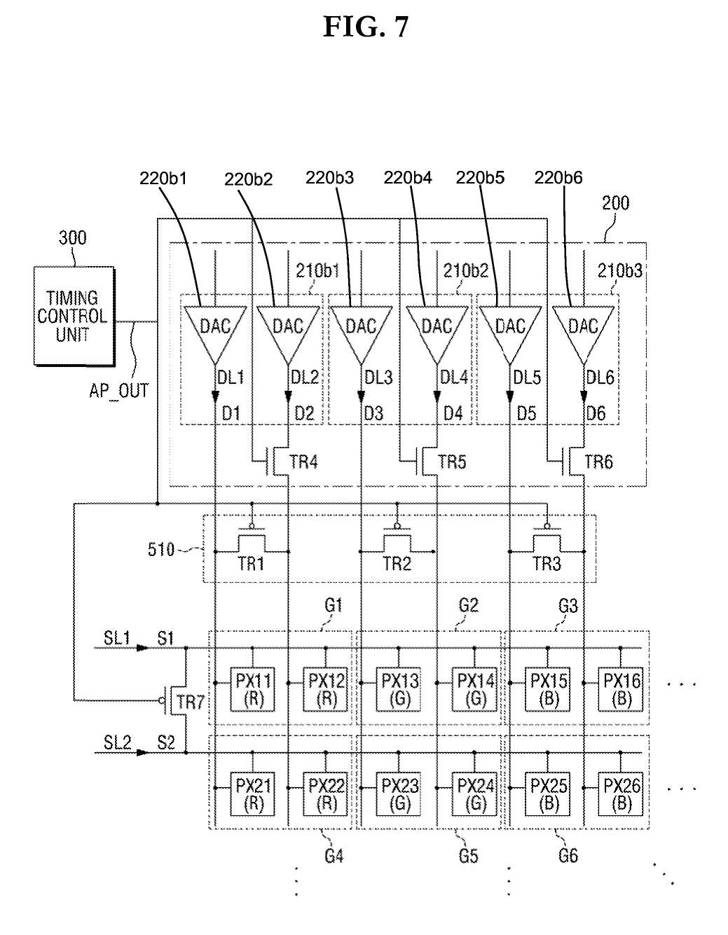

FIG. 6 is a block diagram of an LCD device according to another exemplary embodiment of the invention. FIG. 7 is a detailed block diagram illustrating a data driver 200 and a switching circuit unit 510 illustrated in FIG. 6. The LCD device according to the exemplary embodiment of FIGS. 6 and 7 shares similarities with the LCD device according to the exemplary embodiment of FIGS. 1 to 5, and thus, any redundant descriptions thereof will be omitted.

Referring to FIGS. 6 and 7, the LCD device according to another exemplary embodiment of the invention may include a display panel 100, a data driver 200, a timing control unit 300, a scan driving unit 400 and a switching circuit unit 510.

The display panel 100 may include first through sixth pixel groups G1 through G6. The first pixel group G1 may include first and second pixel units PX11 and PX12, which are connected to first and second data lines DL1 and DL2, respectively, among a plurality of data lines DL1 through DLm. The second pixel group G2 may include third and fourth pixel units PX13 and PX14, which are connected to third and fourth data lines DL3 and DL4, respectively, among the data lines DL1 through DLm. The third pixel group G3 may include fifth and sixth pixel units PX15 and PX16, which are connected to fifth and sixth data lines DL5 and DL6, respectively, among the data lines DL1 through DLm. The fourth pixel group G4, like the first pixel group G1, may be connected to the first and second data lines DL1 and DL2, the fifth pixel group G5, like the second pixel group G2, may be connected to the third and fourth data lines DL3 and DL4, and the sixth pixel group G6, like the third pixel group G3, may be connected to the fifth and sixth data lines DL5 and DL6. The first through third pixel groups G1 through G3 may be connected to a first scan line SL1 among a plurality of scan lines SL1 through SLn, and the fourth through sixth pixel groups G4 through G6 may be connected to a second scan line SL2 among the scan lines SL1 through SLn. Each of the pixel units of each of the first through sixth pixel groups G1 through G6 may receive a data signal via one of the data lines DL1 through DLm connected thereto in response to a scan signal being applied thereto via one of the scan lines SL1 through SLn connected thereto. For this, each of the pixel units of each of the first through sixth pixel groups G1 through G6 may include a transistor, which is turned on by a scan signal and then applies a data signal to a pixel electrode. The pixel units of each of the first through sixth pixel groups G1 through G6 may display the same color together. More specifically, the first and second pixel units PX11 and PX12 of the first pixel group G1 may both display a first color, the third and fourth pixel units PX13 and PX14 of the second pixel group G2 may both display a second color, and the fifth and sixth pixel units PX15 and PX16 of the third pixel group G3 may both display a third color. For example, the first, second and third colors may be red, green and blue, respectively.

The data driver 200 may include a plurality of first through k-th data driving units 210b1 through 210bk (where k is a multiple of 3), and each of the first through k-th data driving units 210b1 through 210bk may include a plurality of DACs. The first data driving unit 210b1 may be connected to the first and fourth pixel groups G1 and G4 via the first and second data lines DL1 through DL2. The second driving unit 210b2 may be connected to the second and fifth pixel groups G2 and G5 via the third and fourth data lines DL3 and DL4. The third driving unit 210b3 may be connected to the third and sixth pixel groups G3 and G6 via the fifth and sixth data lines DL5 and DL6.

The switching circuit unit 510 may include first through third transistors TR1 through TR3. The first transistor TR1 may be connected between the first and second data line DL1 and DL2, receives a control signal AP_OUT from the timing control unit 300, and establishes or blocks a signal path between the first and second data line DL1 and DL2. The second transistor TR2 may be connected between the third and fourth data lines DL3 and DL4, receives the control signal AP_OUT from the timing control unit 300, and establishes or blocks a signal path between the third and fourth data lines DL3 and DL4. The third transistor TR3 may be connected between the fifth and sixth data lines DL5 and DL6, receives the control signal AP_OUT from the timing control unit 300, and establishes or blocks a signal path between the fifth and sixth data lines DL5 and DL6. In an exemplary embodiment, the first through third transistors TR1 through TR3 may be PMOS transistors. The first through third transistors TR1 through TR3 may be turned on in response to a low-level control signal AP_OUT being provided thereto by the timing control unit 300. In an exemplary embodiment, the switching circuit unit 510 may include the first through third transistors TR1 through TR3, and may also include a plurality of other transistors connected to the third to k-th data driving units 210b3 through 210bk.

Referring to FIG. 7, the first data driving unit 210b1 may include first and second DACs 220b1 and 220b2, the second data driving unit 210b2 may include third and fourth DACs 220b3 and 220b4, and the third data driving unit 210b3 may include fifth and sixth DACs 220b5 and 220b6. The first data driving unit 210b1 may also include a fourth transistor TR4, which is connected to one of the first and second DACs 220b1 and 220b2. In an exemplary embodiment, the fourth transistor TR4 may be connected to the second DAC 220b2, as illustrated in FIG. 7. The second data driving unit 210b2 may also include a fifth transistor TR5, which is connected to one of the third and fourth DACs 220b3 and 220b4. In an exemplary embodiment, the fifth transistor TR5 may be connected to the fourth DAC 220b4, as illustrated in FIG. 7. The third data driving unit 210b3 may also include a sixth transistor TR6, which is connected to one of the fifth and sixth DACs 220b5 and 220b6. In an exemplary embodiment, the sixth transistor TR6 may be connected to the sixth DAC 220b6, as illustrated in FIG. 7. The fourth through sixth transistors TR4 through TR6 may receive the control signal AP_OUT from the timing control unit 300, and may establish or block signal paths between the output terminals of the second, fourth and sixth DACs 220b2, 220b4 and 220b6, respectively, and the second, fourth and sixth data lines DL2, DL4 and DL6, respectively, according to the control signal AP_OUT. The fourth through sixth transistors TR4 through TR6 may be turned on in response to a high-level control signal AP_OUT being provided thereto from the timing control unit 300. In an exemplary embodiment, the fourth through sixth transistors TR4 through TR6 may be NMOS transistors. In this exemplary embodiment, the fourth through sixth transistors TR4 through TR6 may be turned on by the high-level control signal AP_OUT. In an exemplary embodiment, the first through third transistors TR1 through TR3 may be PMOS transistors, and the fourth through sixth transistors TR4 through TR6 may be NMOS transistors. However, the invention is not limited to this exemplary embodiment. That is, the first through third transistors TR1 through TR3 and the fourth through sixth transistors TR4 through TR6 are not necessarily limited to any particular switching types as long as the first through third transistors TR1 through TR3 and the fourth through sixth transistors TR4 through TR6 perform switching operations that are complementary to each other. The fourth through sixth transistors TR4 through TR6 may be connected to the input terminals of the second, fourth and sixth DACs 220b2, 220b4 and 220b6, respectively.

In short, the resolution of the LCD device according to another exemplary embodiment of the invention may be adjusted by setting a number of pixel units displaying the same color together as a pixel group and turning on or off first through eighth transistors according to a given driving mode.

What is claimed is:

1. A liquid crystal display device, comprising:
a data driver including a first data driving unit, which is connected to first through third data lines, and a second data driving unit, which is connected to fourth through sixth data lines;
a display panel including a first pixel group, which has first through third pixel units that are connected to the first data driving unit via the first through third data lines, respectively, and a second pixel group, which has fourth through sixth pixel units that are connected to the second data driving unit via the fourth through sixth data lines, respectively; and
a switching circuit unit including a first transistor, which is connected between the first and fourth data lines, a second transistor, which is connected between the second and fifth data lines, and a third transistor, which is connected between the third and sixth data lines.

2. The liquid crystal display device of claim 1, wherein the first data driving unit includes first through third digital-to-analog converters, which are connected to the first through third data lines, respectively, the second data driving unit includes fourth through sixth digital-to-analog converters, which are connected to the fourth through sixth data lines, respectively, and the data driver further includes a fourth transistor, which is connected between the fourth digital-to-analog converter and the fourth data line, a fifth transistor, which is connected between the fifth digital-to-analog converter and the fifth data line, and a sixth transistor, which is connected between the sixth digital-to-analog converter and the sixth data line.

3. The liquid crystal display device of claim 2, wherein the first through third transistors perform a switching operation that is complementary to a switching operation performed by the fourth through sixth transistors.

4. The liquid crystal display device of claim 1, wherein the first through third pixel units display first through third colors, respectively, which are different from one another, and the fourth through sixth pixel units display the first through third colors, respectively.

5. The liquid crystal display device of claim 1, wherein the display panel further includes a third pixel group, which is connected to the first data driving unit via the first through third data lines, and a fourth pixel group, which is connected to the second data driving unit via the fourth through sixth data lines.

6. The liquid crystal display device of claim 5, further comprising:
a scan driving unit connected to the display panel via a plurality of scan lines,
wherein the scan driving unit is connected to the first and second pixel groups via one of the scan lines and is connected to the third and fourth pixel groups via another one of the scan lines.

7. The liquid crystal display device of claim 5, further comprising:
a seventh transistor connected between the scan line to which the first and second pixel groups are connected and the scan line to which the third and fourth pixel groups are connected,
wherein the scan driving unit further includes a shift register, which provides a scan signal to the scan line to which the third and fourth pixel groups are connected, and an eighth transistor, which is connected to the scan line to which the third and fourth pixel groups are connected.

8. The liquid crystal display device of claim 7, wherein the seventh transistor performs a switching operation that is complementary to a switching operation performed by the eighth transistors.

9. A liquid crystal display device, comprising:
a data driver including a first data driving unit, which provides first through third data signals via first through third data lines, respectively, and a second data driving unit, which provides fourth through sixth data signals via fourth through sixth data lines, respectively;
a display panel including a first pixel group, which has first through third pixel units that are provided with the first through third data signals, respectively, and a second pixel group, which has fourth through sixth pixel units that are provided with the fourth through sixth data signals, respectively;
a switching circuit unit including a first transistor, which is connected between the first and fourth data lines, a second transistor, which is connected between the second and fifth data lines, and a third transistor, which is connected between the third and sixth data lines; and
a timing control unit turning on the first through third transistors by providing a first control signal to the switching circuit unit during a first driving mode and turning off the first through third transistors by providing a second control signal to the switching circuit unit during a second driving mode.

10. The liquid crystal display device of claim 9, wherein the data driver includes a first transistor, which establishes or blocks a signal path between the first and fourth data lines in response to the first or second control signal being provided thereto, a second transistor, which establishes or blocks a signal path between the second and fifth data lines in response to the first or second control signal being provided thereto, and a third transistor, which establishes or blocks a signal path between the third and sixth data lines in response to the first or second control signal being provided thereto.

11. The liquid crystal display device of claim 9, wherein the first data driving unit includes first through third digital-to-analog converters, which are connected to the first through third data lines, respectively, the second data driving unit includes fourth through sixth digital-to-analog converters, which are connected to the fourth through sixth data lines, respectively, and the data driver further includes fourth through sixth transistors, which block signal paths between output terminals of the fourth through sixth digital-to-analog converters, respectively, and the fourth through sixth data lines, respectively, during the first driving mode.

12. The liquid crystal display device of claim 9, wherein the first through third pixel units display first through third colors, respectively, which are different from one another, and the fourth through sixth pixel units display the first through third colors, respectively.

13. The liquid crystal display device of claim 9, further comprising:
a scan driving unit including a plurality of shift registers, which provide a plurality of scan signals via the display panel and a plurality of scan lines,
wherein the first and second pixel groups are provided with a scan signal via one of the scan lines.

14. The liquid crystal display device of claim 13, wherein the display panel further includes a third pixel group, which receives the first through third data signals from the first data driving unit, and a fourth pixel group, which receives the fourth through sixth data signals from the second data driving unit, and the third and fourth pixel groups are provided with a scan signal via another one of the scan lines.

15. The liquid crystal display device of claim 14, further comprising:
a seventh transistor establishing a signal path between the scan line to which the first and second pixel groups are connected and the scan line to which the third and fourth pixel groups are connected during the first driving mode and blocking the signal path between the scan line to which the first and second pixel groups are connected and the scan line to which the third and fourth pixel groups are connected during the second driving mode,
wherein the scan driving unit blocks a signal path between one of the shift registers providing a scan signal to the third and fourth pixel groups and the scan line to which the third and fourth pixel groups are connected, during the first driving mode.

16. A liquid crystal display device, comprising:
a display panel including a first pixel group, which has first and second pixel units that display a first color, a second pixel group, which has third and fourth pixel units that display a second color, and a third pixel group, which has fifth and sixth pixel units that display a third color;
a data driver including a first data driving unit, which is connected to the first and second pixel units via first and second data lines, respectively, a second data driving unit, which is connected to the third and fourth pixel units via third and fourth data lines, respectively, and a third data driving unit, which is connected to the fifth and sixth pixel units via fifth and sixth data lines, respectively; and
a switching circuit unit including a first transistor, which is connected between the first and second data lines, a second transistor, which is connected between the third and fourth data lines, and a third transistor, which is connected between the fifth and sixth data lines.

17. The liquid crystal display device of claim 16, wherein the data driver further includes first through sixth DACs, which are connected to the first through sixth data lines, respectively, the first data driving unit includes a fourth transistor, which is connected between the second digital-to-analog converter and the second data line, the second data driving unit includes a fifth transistor, which is connected between the fourth digital-to-analog converter and the fourth data line, and the third data driving unit includes a sixth transistor, which is connected between the sixth digital-to-analog converter and the sixth data line.

18. The liquid crystal display device of claim 17, wherein the first through third transistors perform a switching operation that is complementary to a switching operation performed by the fourth through sixth transistors.

19. The liquid crystal display device of claim 16, wherein the display panel further includes a fourth pixel group, which is connected to the first data driving unit via the first and second data lines, a fifth pixel group, which is connected to the second data driving unit via the third and fourth data lines, and a sixth pixel group, which is connected to the third data driving unit via the fifth and sixth data lines.

20. The liquid crystal display device of claim 19, further comprising:
a scan driving unit connected to the first through third pixel groups via one of a plurality of scan lines and to the fourth through sixth pixel groups via another one of the scan lines; and
a seventh transistor connected between the scan line to which the first through third pixel groups are connected and the scan line to which the fourth through sixth pixel groups are connected,
wherein the scan driving unit includes an eighth transistor, which is connected between the scan line to which the fourth through sixth pixel groups are connected and an output terminal of a shift register providing a scan signal to the scan line to which the fourth through sixth pixel groups are connected.
